(19) United States
(12) Patent Application Publication
(10) Pub. No.: US 2025/0262614 A1
(43) Pub. Date: Aug. 21, 2025

(54) HONEYCOMB SHAPE CATALYST FOR DECOMPOSITION OF PERFLUORINATED COMPOUNDS

(71) Applicant: ECOPROHN CO., LTD., Chungcheongbuk-do (KR)

(72) Inventors: DONG WOO KIM, Chungcheongbuk-do (KR); MIN JI KIM, Chungcheongbuk-do (KR); SEUNG HWAN JI, Chungcheongnam-do (KR); KWAN HYOUNG JEONG, Chungcheongnam-do (KR); HYE JIN AN, Chungcheongbuk-do (KR); HA NEUL JANG, Chungcheongbuk-do (KR)

(21) Appl. No.: 19/059,771

(22) Filed: Feb. 21, 2025

(30) Foreign Application Priority Data
Feb. 21, 2024 (KR) 10-2024-0024748
Jan. 22, 2025 (KR) 10-2025-0009411

(51) Int. Cl. B01J 35/57; B01J 21/04; B01J 35/31; B01J 35/61; B01J 35/63; B01J 35/64

(52) U.S. Cl. CPC B01J 35/57; B01J 21/04; B01J 35/31; B01J 35/613; B01J 35/633; B01J 35/635; B01J 35/647

(57) ABSTRACT

A honeycomb-shaped catalyst for decomposition of perfluorinated compounds includes a body, a plurality of channels which penetrate the body from one surface thereof to a surface facing the one surface, and partition walls configured to define the channels. The honeycomb-shaped catalyst includes aluminum oxide and has a density of 300 g/L or more.

### CROSS REFERENCE TO RELATED APPLICATIONS AND CLAIM OF PRIORITY

This application claims the benefit under 35 USC § 119 (a) of Korean Patent Application Nos. 10-2024-0024748 filed on Feb. 21, 2024 and 10-2025-0009411 filed on Jan. 22, 2025, in the Korean Intellectual Property Office, the entire disclosure of which are incorporated herein by reference for all purposes.

### BACKGROUND

### 1. Field of the Invention

The present invention relates to a honeycomb-shaped catalyst for decomposition of perfluorinated compounds.

### 2. Description of the Related Art

Perfluorinated compounds (PFCs) are a type of organic fluorine compounds, and refer to compounds containing an excessive amount of fluorine (F) atoms. Functional groups of the perfluorinated compound may include halogen, a carboxyl group, an oxy group, a sulfonic acid group, etc. Examples of the perfluorinated compound include carbon tetrafluoride (CF₄), perfluoroheptanoic acid, polytetrafluoroethylene (PTFE), etc.

The perfluorinated compounds may be used as etchants and cleaners in a semiconductor manufacturing process. The perfluorinated compounds have a high global warming potential and a low decomposition rate due to their high stability, such that they remain in the surrounding environment to cause environmental pollution. In addition, the perfluorinated compounds may remain in the human body, thereby causing diseases such as thyroid disease, hormonal disease, diabetes and the like.

As the use of perfluorinated compounds is increased according to an increase in the demand for semiconductors, and the environmental protection issue is emerging, the demand for decomposition of perfluorinated compounds is increasing. As a method for decomposition of perfluorinated compounds, decomposition using a catalyst is known in the art. For example, in the case of CF₄ among the perfluorinated compounds, it is decomposed at a high temperature of 1,000° C. or higher, but when using the catalyst, it may be decomposed at a temperature of about 700° C. to 750° C.

When the catalyst is exposed to the perfluorinated compounds for a long period of time, damage to a surface structure of the catalyst may occur due to adsorption/desorption of fluorine on the surface thereof, and thereby causing a reduction in durability of the catalyst. In addition, when a gas containing perfluorinated compounds is passed through a catalyst accommodated in a chamber, there is difficulty in long-term operation due to pressure loss caused by a difference in pressures before and after permeation.

Korean Patent Laid-Open Publication No. 10-2023-0083099 discloses a catalyst for decomposition of perfluorinated compounds including a rare earth metal. However, in consideration of energy efficiency, a catalyst capable of decomposing perfluorinated compounds at a relatively low temperature is required. In addition, according to the improved durability, a catalyst with improved lifespan characteristics is required.

### SUMMARY

An object of the present invention is to provide a honeycomb-shaped catalyst for decomposition of perfluorinated compounds having improved decomposition efficiency and lifespan.

Another object of the present invention is to provide a honeycomb-shaped catalyst assembly for decomposition of perfluorinated compounds having improved decomposition efficiency and lifespan.

In addition, another object of the present invention is to provide a method for removing perfluorinated compounds using the catalyst for decomposition of perfluorinated compounds and the assembly thereof.

To achieve the above objects, according to an aspect of the present invention, there is provided a honeycomb-shaped catalyst for decomposition of perfluorinated compounds including: a body; a plurality of channels which penetrate the body from one surface thereof to a surface facing the one surface; and partition walls configured to define the channels, wherein the catalyst includes aluminum oxide, and has a density of 300 g/L or more.

According to some embodiments, the catalyst may have a density of 400 g/L to 1,000 g/L.

According to some embodiments, the catalyst may have the number of channels per square inch (CPSI) of 30 to 150.

According to some embodiments, the catalyst may further include pores, wherein the pores may have an average diameter of 50 Å to 300 Å.

According to some embodiments, a volume of the pores included per unit mass of the catalyst may be 0.2 cm³/g to 0.6 cm³/g.

According to some embodiments, the catalyst may have a porosity of 10 to 100, which is defined by Equation 1 below:

$$Porosity = ( PV / PD ) \times {10}^{4} \qquad [ Equation 1 ]$$

In Equation 1, PV may be a numerical value of the volume of the pores included per unit mass (cm³/g) of the catalyst, and PD may be a numerical value of the average diameter (Å) of the pores included in the catalyst.

According to some embodiments, the catalyst may have a surface area per unit mass of 40 m²/g or more.

According to some embodiments, the catalyst may have a catalyst material distribution index of 70 to 500, which is defined by Equation 2 below:

$$Catalyst material distribution index = \{ D \times ( L 1 / L 2 ) \} \times 100 \qquad [ Equation 2 ]$$

In Equation 2, D may be a numerical value of a density (kg/L) of the catalyst, L1 may be a numerical value of a length (mm) of the channel of the catalyst, and L2 may be a numerical value of the shortest distance (mm) between two adjacent channels of the catalyst.

According to some embodiments, a content of the aluminum oxide may be 40% by weight to 95% by weight based on a total weight of the catalyst.

According to some embodiments, the aluminum oxide may include at least one of alpha-alumina (α-Al₂O₃), beta-alumina (β-Al₂O₃), gamma-alumina (γ-Al₂O₃), delta-alumina (δ-Al₂O₃), theta-alumina (θ-Al₂O₃) and kappa-alumina (κ-Al₂O₃).

According to some embodiments, the catalyst may have a strength reduction rate of 45% or less, which is defined by Equation 3 below:

$$Strength reduction rate ( \% ) = 100 - [ \{ 1 - ( {S}_{E} / {S}_{I} ) \} \times 100 ] \qquad [ Equation 3 ]$$

In Equation 3, S_{E} may be a strength of the catalyst measured after passing a gas containing perfluorinated compounds for 300 hours, and S_{I} may be a strength of the catalyst measured without passing the gas containing perfluorinated compounds.

According to some embodiments, the catalyst may have a surface area reduction rate of 75% or less, which is defined by Equation 4 below:

$$Surface area reduction rate ( \% ) = 100 - [ \{ 1 - ( {A}_{F} / {A}_{I} ) \} \times 100 ] \qquad [ Equation 4 ]$$

In Equation 4, A_{E} may be a surface area of the catalyst measured after exposure to 950° C. for 4 hours, and A_{I} may be a surface area of the catalyst measured without exposure to heat.

According to another aspect of the present invention, there is provided a honeycomb-shaped catalyst assembly for decomposition of perfluorinated compounds, including a plurality of the above-described honeycomb-shaped catalysts for decomposition of perfluorinated compounds, which are stacked so that channels of the catalysts are connected with each other.

In addition, according to another aspect of the present invention, there is provided a method for removing perfluorinated compounds including: preparing the above-described honeycomb-shaped catalyst assembly for decomposition of perfluorinated compounds; and injecting a gas containing perfluorinated compounds into one surface of the honeycomb-shaped catalyst assembly for decomposition of perfluorinated compounds.

The honeycomb-shaped catalyst for decomposition of perfluorinated compounds according to the embodiments of the present invention includes aluminum oxide and has a density in a predetermined range or more. Accordingly, decomposition efficiency of perfluorinated compounds may be improved.

According to exemplary embodiments, the shape of the honeycomb-shaped catalyst for decomposition of perfluorinated compounds may be adjusted. Accordingly, lifespan characteristics of the catalyst for decomposition of perfluorinated compounds may be improved.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 are a perspective view and a plan view schematically illustrating a honeycomb-shaped structure of a honeycomb-shaped catalyst for decomposition of perfluorinated compounds according to exemplary embodiments, respectively; and

FIG. 3 is a schematic cross-sectional view illustrating a reactor including a catalyst assembly according to exemplary embodiments.

### DETAILED DESCRIPTION OF THE INVENTION

Hereinafter, embodiments of the present disclosure will be described in detail. However, these embodiments are merely an example, and the present disclosure is not limited to the specific embodiments described as the example.

The exemplary embodiments of the present invention provide a honeycomb-shaped catalyst (hereinafter, may be abbreviated as a “catalyst 100”) for decomposition of perfluorinated compounds including aluminum oxide and having a density in a predetermined range. In addition, a honeycomb-shaped catalyst assembly (hereinafter, may be abbreviated as a “catalyst assembly 200”) for decomposition of perfluorinated compounds including the honeycomb-shaped catalysts for decomposition of perfluorinated compounds is provided. In addition, a method for removing perfluorinated compounds using the catalyst is provided.

The term “contact area” as used herein may mean an area which is adjusted by the shape of the catalyst 100. For example, the contact area may be controlled by adjusting the number of channels per square inch (CPSI).

The term “surface area” as used herein may mean an area which is adjusted by pores included in the catalyst 100. For example, the surface area may be controlled by adjusting the size, volume, number, etc. of micropores included in the catalyst 100.

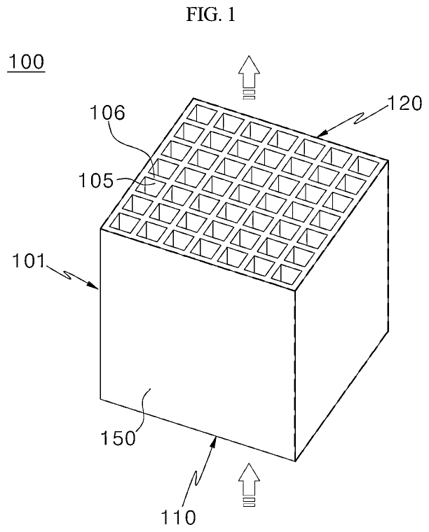

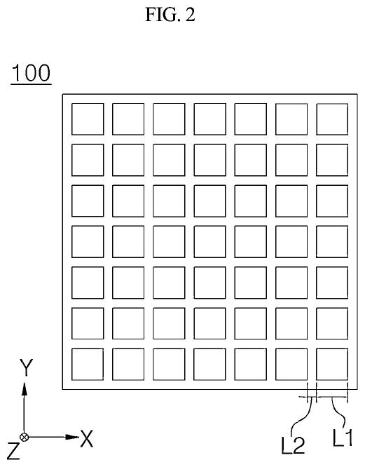

FIGS. 1 and 2 are a perspective view and a plan view schematically illustrating the structure of a honeycomb-shaped catalyst for decomposition of perfluorinated compounds according to exemplary embodiments, respectively. For example, FIG. 2 is a view illustrating an upper surface of the honeycomb-shaped catalyst for decomposition of perfluorinated compounds according to exemplary embodiments.

As used herein, the “height direction” may refer to a direction in which channels are formed. For example, the height direction may refer to a direction in which a gas containing perfluorinated compounds permeates. For example, the height direction may refer to a direction perpendicular to an x-axis direction and a y-axis direction in FIG. 2.

Referring to FIG. 1, the catalyst 100 may have a honeycomb shape including a plurality of channels 105. For example, the catalyst 100 may include a body 101, the plurality of channels 105 and partition walls 106 configured to define the channels 105.

In one embodiment, when perfluorinated compounds pass through the catalyst 100, an area in contact with the catalyst 100 may be increased through the plurality of channels 105, thereby increasing the decomposition efficiency of the perfluorinated compound.

According to exemplary embodiments, the plurality of channels 105 may penetrate the body from one surface thereof to a surface facing the one surface. For example, the channels 105 may penetrate the body in a direction from a first surface 110 to a second surface 120 facing the first surface 110.

According to exemplary embodiments, the channels 105 may be formed in the height direction. For example, the first surface 110 and the second surface 120 may be connected through the channels 105.

According to exemplary embodiments, cross-sectional shapes of the channel 105 may be constant throughout the sections in the height direction. For example, when lateral faces 150 are cut in the height direction of the catalyst 100 parallel to the first surface 110 and the second surface 120, the cross-sectional shape of the channel 105 in a middle section may be the same as the cross-sectional shape of the channel on the first surface 110 and/or the cross-sectional shape of the channel on the second surface 120. The gas containing perfluorinated compounds may pass through the plurality of channels 105 penetrating the catalyst 100.

The cross-sectional shape of the channel 105 may not be limited to the cross-sectional shape shown in FIG. 1. For example, the cross-sectional shape of the channel 105 may correspond to a triangle, a rectangle, a square, a trapezoid, a rhombus, a hexagon, an oval, a circle and the like. In consideration of the contact area between the gas and the catalyst 100, a flow rate, a density of the catalyst material included in the catalyst 100, a strength of the catalyst 100, and the like, the cross-sectional shape of the channel 105 may be formed as a triangle, a rectangle, or a hexagon.

According to exemplary embodiments, the plurality of channels 105 may be defined through the partition walls 106.

In exemplary embodiments, the body 101 and the partition walls 106 may be made of the same material.

In some embodiments, the plurality of channels 105 may be spaced apart from each other at a predetermined interval. For example, the channels 105 may be spaced apart from each other in a direction perpendicular to the height direction by a distance corresponding to a thickness of the partition walls 106.

In one embodiment, each of the plurality of channels 105 may have a rectangular cross-section, and distances (e.g., L2 in FIG. 2) between the plurality of channels 105 may be the same as each other.

In exemplary embodiments, the shape of the channel 105, the number of the channels 105, etc. may be adjusted to further improve the decomposition efficiency of perfluorinated compounds in the catalyst 100.

In exemplary embodiments, a diameter of the channel 105 may be measured from a diameter of the channel located on the first surface 110 or the second surface 120. For example, the diameter of the channel may be measured from the cross-section of the channel 105 identified on the first surface 110.

According to exemplary embodiments, the catalyst 100 may have the number of channels per square inch (CPSI) of 20 or more. In some embodiments, the catalyst 100 may have the number of channels per square inch of 25 or more, 27 or more, 29 or more, or 30 or more.

In the present specification, the number of channels per square inch may be a value measured in a cross-section perpendicular to the height direction of the channels of the catalyst 100.

According to exemplary embodiments, the number of channels per square inch of the catalyst 100 may be 250 or less. In some embodiments, the number of channels per square inch of the catalyst 100 may be 220 or less, 200 or less, 180 or less, 150 or less, or 130 or less.

For example, the number of channels per square inch of the catalyst 100 may be 20 to 250, 25 to 200, 27 to 180, 29 to 150, 30 to 150, or 30 to 130.

Within the above range, a unit area capable of being in contact with the perfluorinated compounds may be increased, and mobility of the gas may be maintained, thereby increasing catalytic activity per unit time.

In order to improve the lifespan, decomposition efficiency, etc. of the catalyst, the structure of the catalyst 100 may be adjusted. The structure of the catalyst 100 may be adjusted within a range enough to maintain the pores, density, strength, etc.

For example, longitudinal and lateral lengths of the catalyst 100 may be 10 mm to 30 mm, respectively. The longitudinal and lateral lengths may represent the length and width of the first section 110 or the second section 120. For example, the catalyst 100 may have a height of 10 mm to 25 mm. The length is exemplary, and the size of the catalyst 100 is not limited thereto.

In exemplary embodiments, the catalyst 100 may include a catalyst material including a metal oxide having catalytic activity for decomposition of perfluorinated compounds.

According to exemplary embodiments, the catalyst 100 may include a catalyst material having catalytic activity.

In some embodiments, the catalyst material may include a metal oxide catalyst material. For example, the metal oxide catalyst material may include aluminum oxide, such as aluminum (I) oxide (Al₂O₃), aluminum (II) oxide (AlO₃), aluminum (II) oxide (Al₂O₃).

According to exemplary embodiments, the aluminum oxide may include one or more of alpha-alumina (α-Al₂O₃), beta-alumina (β-Al₂O₃), gamma-alumina (γ-Al₂O₃), delta-alumina (δ-Al₂O₃), theta-alumina (θ-Al₂O₃) and kappa-alumina (κ-Al₂O₃). In one embodiment, the aluminum oxide may include one or more of alpha-alumina (α-Al₂O₃) and gamma-alumina (γ-Al₂O₃).

In exemplary embodiments, the catalyst 100 may further include a ceramic material within a range that does not inhibit the catalytic activity of the catalyst material. For example, the catalyst 100 may further include a ceramic material such as silica, zeolite, cordierite, mullite, silica-alumina, titania, magnesia, Fe₂O₃/TiO₂, Fe₂O₃/Al₂O₃, MgO/TiO₂, ZrO₂/Al₂O₃, ZrOx/TiO₂, CeO₂/TiO₂, CeO₂/ZrO₂, V₂₀₅/TiO₂, etc.

According to exemplary embodiments, the catalyst 100 may include 40% by weight (“wt %”) to 95 wt %, 50 wt % to 95 wt %, 50 wt % to 85 wt %, 50 wt % to 80 wt %, 50 wt % to 75 wt %, or 50 wt % to 70 wt % of the aluminum oxide catalyst material based on a total weight of the catalyst.

Within the above range, the decomposition efficiency of the perfluorinated compound may be maintained for a long period of time, and thermal stability may be improved.

In some embodiments, the catalyst 100 may further include elements such as oxygen (O), zirconium (Zr), zinc (Zn), tungsten (W), cerium (Ce), gallium (Ga), nickel (Ni), phosphorus (P), sulfur(S), and boron (B), etc. For example, the catalyst 100 may further include a material formed of the above-described elements in addition to the aluminum oxide catalyst material.

In some embodiments, the catalyst 100 may have a monolithic structure in which components thereof are formed integrally with each other.

For example, an active ingredient such as aluminum oxide, a ceramic material, and the like may be mixed to form a slurry, and the slurry may be injected to form the catalyst 100 including the body 101, the plurality of channels 105, and the partition walls 106 which define the channels 105. Accordingly, an amount of the active ingredient included in the catalyst 100 may be increased. In addition, the catalyst 100 having the above-described channel characteristics, pore characteristics, density, etc. may be reproducibly implemented.

The perfluorinated compound removal efficiency, lifespan characteristics, pressure loss, etc. of the catalyst 100 may be improved.

In exemplary embodiments, the catalyst 100 may have a density of 300 g/L or more. In some embodiments, the catalyst 100 may have a density of 350 g/L or more, 370 g/L or more, 380 g/L or more, 390 g/L or more, or 400 g/L or more.

According to exemplary embodiments, the catalyst 100 may have a density of 1,100 g/L or less.

In some embodiments, the catalyst 100 may have a density of 1,080 g/L or less, 1,050 g/L or less, 1,030 g/L or less, 1,020 g/L or less, 1,010 g/L or less, or 1,000 g/L or less. For example, the catalyst 100 may have a density of 300 g/L to 1,100 g/L, 350 g/L to 1,080 g/L, 370 g/L to 1,050 g/L, 380 g/L to 1,030 g/L, 390 g/L to 1,020 g/L, or 400 g/L to 1,000 g/L.

For example, if the density exceeds the above range, the diameter, volume, surface area, etc. of the channel may be decreased, and the decomposition efficiency of the perfluorinated compound decomposed by the unit mass of the catalyst may be reduced.

For example, if the density is less than the above range, a change in the size of the channel and/or pores may occur depending on the flow rate of the gas in a gas injection process. Thereby, the durability of the catalyst 100 may be decreased, and the amount of the catalyst material included in the catalyst 100 may be too small, thus to reduce the decomposition efficiency of the perfluorinated compound.

In exemplary embodiments, the catalyst 100 may include pores. For example, the volume of the pores included in the catalyst 100 may be controlled to further improve the decomposition efficiency of the perfluorinated compound.

The pores may refer to micropores included in the entire structure including the partition walls 106 of the catalyst 100.

According to exemplary embodiments, the pores may have an average diameter of 50 Å to 300 Å, 52 Å to 280 Å, 54 Å to 260 Å, 55 Å to 250 Å, 58 Å to 200 Å, or 60 Å to 200 Å. In some embodiments, the pores may have an average diameter of 50 Å to 90 Å, 50 Å to 80 Å, or 50 Å to 75 Å.

For example, the average diameter of the pores may be measured by Brunauer-Emmett-Teller (BET) analysis. For example, the “average diameter” may represent the longest diameter of the pores at a point corresponding to 50% in a cumulative distribution where the pores are arranged in order of size. For example, the average diameter of the pores may be a value measured when the catalyst 100 is exposed to 600° C. For example, when the catalyst 100 is exposed to a high temperature (e.g., 1,000° C.), the average diameter may be increased. Within the above diameter range, a differential pressure in the process of decomposing the perfluorinated compounds may be reduced, and thus damage to the catalyst 100 may be suppressed.

According to exemplary embodiments, a volume of the pores included per unit mass of the catalyst 100 may be 0.2 cm³/g or more.

In some embodiments, the volume of the pores included per unit mass of the catalyst 100 may be 0.25 cm³/g or more, 0.30 cm³/g or more, 0.32 cm³/g or more, 0.35 cm³/g or more, 0.38 cm³/g or more, or 0.40 cm³/g or more.

According to exemplary embodiments, the volume of the pores included per unit mass of the catalyst 100 may be 0.65 cm³/g or less, 0.62 cm³/g or less, 0.60 cm³/g or less, 0.58 cm³/g or less, or 0.56 cm³/g or less.

For example, the volume of the pores included per unit mass of the catalyst 100 may be 0.2 cm³/g to 0.65 cm³/g, 0.2 cm³/g to 0.60 cm³/g, 0.30 cm³/g to 0.60 cm³/g, 0.35 cm³/g to 0.60 cm³/g, or 0.40 cm³/g to 0.56 cm³/g.

Within the above volume range, the efficiency of the catalytic activity per unit time may be increased while securing the durability of the catalyst 100.

For example, if the volume exceeds the above range, the strength of the catalyst 100 may be reduced, thereby causing a damage thereto in the decomposition process. For example, if the volume is less than the above range, the surface area per unit time of the catalyst and the gas containing perfluorinated compounds may be decreased, thereby decreasing the decomposition efficiency.

In exemplary embodiments, the volume of the pores and the average diameter of the pores included in the catalyst 100 may be measured by the BET method. For example, the volume of the pores and the average diameter of the pores may be values measured in an environment of 500° C.

The durability and lifespan of the catalyst may be improved by adjusting the density of the catalyst 100, the size and number of the pores included in the catalyst 100, etc., while maintaining the improved decomposition efficiency.

According to exemplary embodiments, the catalyst 100 may have a porosity of 10 to 100, which is defined by Equation 1 below.

$$Porosity = ( PV / PD ) \times {10}^{4} \qquad [ Equation 1 ]$$

In Equation 1, PV is a numerical value of the volume of the pores included per unit mass (cm³/g) of the catalyst 100, and PD is a numerical value of the average diameter (Å) of the pores included in the catalyst 100.

In exemplary embodiments, the porosity may be a dimensionless number.

According to exemplary embodiments, the porosity may be 15 to 90, 20 to 80, 25 to 75, or 30 to 70. Within the above range, the surface area of the catalyst 100 may be increased, thereby further improving the removal efficiency of perfluorinated compounds.

In exemplary embodiments, the catalyst 100 may come into contact with the perfluorinated compounds through contact surfaces including the first surface 110, the second surface 120 and surfaces of the inner partition walls 106.

For example, the contact area of the contact surfaces may be calculated as an area where the gas containing perfluorinated compounds and the catalyst 100 substantially come into contact with each other, except for an area of the lateral faces 150 of the catalyst 100.

In exemplary embodiments, the surface area of the catalyst 100 may be controlled by adjusting the size of the pores, the volume of the pores, etc.

In some embodiments, the catalyst 100 may have a surface area per unit mass of 40 m²/g or more.

In some embodiments, the catalyst 100 may have a surface area per unit mass of 60 m²/g or more, 75 m²/g or more, 90 m²/g or more, 100 m²/g or more, 120 m²/g or more, 140 m²/g or more, or 150 m²/g or more.

Within the above surface area range, heat transfer may occur smoothly even at a relatively low temperature, thereby further enhancing the decomposition efficiency of the perfluorinated compounds.

According to exemplary embodiments, the catalyst 100 may have a catalyst material distribution index of 70 to 500, which is defined by Equation 2 below.

$$Catalyst material distribution index = \{ D \times ( L 1 / L 2 ) \} \times 100 \qquad [ Equation 2 ]$$

In Equation 2, D is a numerical value of a density (kg/L) of the catalyst 100, L1 is a numerical value of a length (mm) of the channel 105 of the catalyst 100, and L2 is a numerical value of the shortest distance (mm) between two adjacent channels of the catalyst 100.

In exemplary embodiments, the catalyst material distribution index may be a dimensionless number.

According to exemplary embodiments, the catalyst material distribution index may be 80 to 450, 85 to 400, 90 to 350, 95 to 300, or 100 to 250. When satisfying the above range, a decrease in the catalytic efficiency due to the reduction in the surface area may be prevented, while preventing a decrease in the strength and durability of the catalyst 100 and a decrease in the lifespan characteristics.

In Equation 2, the channel length L1 may represent a length (mm) in an x-direction of the channel 105 of the catalyst 100, or otherwise, may represent a length (mm) in a y-direction of the channel 105.

In Equation 2, the thickness L2 of the partition wall 106 is the shortest distance (mm) between two adjacent channels 105 of the catalyst 100, and for example, may represent a length (mm) in the x direction between two adjacent channels 105.

According to exemplary embodiments, the catalyst 100 may have a strength of 4 kgf/cm² or more.

The strength may be measured according to the method known in the art, and may represent a value measured from the catalyst 100 in the shape of a cube with each side having a length of 50 mm. In some embodiments, the catalyst 100 may have a strength of 6 kgf/cm² or more, 8 kgf/cm² or more, 10 kgf/cm² or more, 12 kgf/cm² or more, or 14 kgf/cm² or more.

According to exemplary embodiments, the catalyst 100 may have a strength of 60 kgf/cm² or less. In some embodiments, the catalyst 100 may have a strength of 59 kgf/cm² or less, 58 kgf/cm² or less, 57 kgf/cm² or less, 56 kgf/cm² or less, or 55 kgf/cm² or less.

For example, the catalyst 100 may have a strength of 4 kgf/cm² to 60 kgf/cm², 6 kgf/cm² to 59 kgf/cm², 8 kgf/cm² to 58 kgf/cm², 10 kgf/cm² to 56 kgf/cm², or 14 kgf/cm² to 55 kgf/cm².

Even if an external impact and an internal differential pressure are applied to the catalyst 100 within the above range, the shape thereof may be maintained. Accordingly, the durability and lifespan of the catalyst may be improved.

For example, a gas containing perfluorinated compounds may be injected into the first surface 110 of the catalyst 100. A gas containing compounds generated by the decomposition of the perfluorinated compounds may be discharged through the second surface 120 of the catalyst 100.

According to exemplary embodiments, a pressure loss value measured when the gas passes through the catalyst 100 in a flow rate of 90 CMM/m2 may be 0.30 mmH₂O/m or less, 0.25 mmH₂O/m or less, 0.22 mmH₂O/m or less, or 0.20 mmH₂O/m or less.

Within the above range, energy consumption for gas flow of the catalyst 100 may be reduced. In addition, local reaction overload inside the catalyst 100 may be suppressed, thereby improving the decomposition efficiency.

For example, the differential pressure may appear in the process of permeating the gas containing perfluorinated compounds from the first surface 110 to the second surface 120. For example, while permeating the gas containing perfluorinated compounds through the catalyst 100, the differential pressure may be calculated from the pressure measured at the first surface 110 and the pressure measured at the second surface 120, and the pressure loss may be determined from the calculated differential pressures.

For example, the improved perfluorinated compound removal efficiency of the catalyst 100 may be maintained.

According to exemplary embodiments, the catalyst 100 may have a strength reduction rate of 45% or less, 40% or less, 35% or less, 30% or less, 25% or less, 20% or less, 15% or less, 10% or less, 8% or less, or 5% or less, which is defined by Equation 3 below.

$$Strength reduction rate ( \% ) = 100 - [ \{ 1 - ( {S}_{E} / {S}_{I} ) \} \times 100 ] \qquad [ Equation 3 ]$$

In Equation 3, S_{E} is a strength of the catalyst 100 measured after passing a gas containing perfluorinated compounds for 300 hours, and S_{I} is a strength of the catalyst 100 measured without passing the gas containing perfluorinated compounds.

The strength of the catalyst 100 may be measured according to the method known in the art. For example, the strength may be measured by a Brinell hardness test, a Rockwell hardness test, a Vickers hardness test, a Shore hardness test and the like.

Within the above range, the structure of the catalyst 100 may be maintained for a long period of time, thereby improving the process efficiency for removing the perfluorinated compounds.

According to exemplary embodiments, the catalyst 100 may have a surface area reduction rate of 75% or less, 70% or less, 60% or less, 50% or less, 45% or less, 43% or less, 40% or less, 30% or less, or 25% or less, which is defined by Equation 4 below.

$$Surface area reduction rate ( \% ) = 100 - [ \{ 1 - ( {A}_{E} / {A}_{I} ) \} \times 100 ] \qquad [ Equation 4 ]$$

In Equation 4, A_{E} is a surface area of the catalyst 100 measured after exposure to 950° C. for 4 hours, and A_{I} is a surface area of the catalyst 100 measured without exposure to heat.

Within the above range, the thermal stability of the catalyst 100 may be secured. In addition, even if the catalyst 100 is exposed to a high temperature due to an instantaneous overreaction, the structure may be maintained.

In exemplary embodiments, a plurality of catalysts 100 may be stacked to form the catalyst assembly 200.

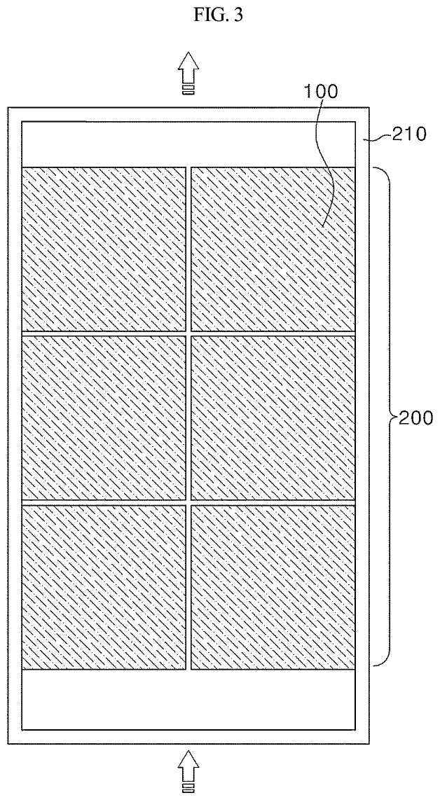

FIG. 3 is a schematic cross-sectional view illustrating a reactor including the catalyst assembly 200 according to exemplary embodiments.

Referring to FIG. 3, the reactor may include a chamber 210 and the catalyst assembly 200 disposed within the chamber 210. The catalyst assembly 200 in which a plurality of the above-described catalysts are stacked may be disposed within the reactor. In FIG. 3, the catalysts 100 are illustrated separately for the convenience of description, but the plurality of catalysts 100 may be in direct contact with each other.

According to exemplary embodiments, in the catalysts including the plurality of catalysts 100, the respective channels may be connected with each other to allow a fluid to pass therethrough.

For example, the plurality of catalysts 100 may each include the channels having the same diameter, and the second surface 120 of one catalyst 100 and the first surface 110 of another catalyst 100 may be stacked to face each other with being contact each other so that the channels are connected to form the catalyst assembly 200.

For example, the lateral faces 150 of the same plurality of catalysts 100 may be adhered to form the catalyst assembly 200.

The number of catalysts 100 included in the catalyst assembly 200 is not limited, but may be determined in consideration of the volume of the reactor.

The gas containing perfluorinated compounds may be injected into one end (e.g., inlet) of the reactor. For example, the gas containing perfluorinated compounds may come into contact with the catalyst assembly 200 in a direction indicated by arrows in FIG. 3, and the gas containing compounds generated by the decomposition of the perfluorinated compounds may be discharged through the other end (e.g., outlet) of the reactor.

The catalyst assembly 200 including the catalysts according to the above-described embodiments may exhibit the improved perfluorinated compound removal efficiency. In addition, the catalyst assembly 200 may be used continuously and repeatedly.

According to exemplary embodiments, an initial perfluorinated compound removal efficiency of the catalyst assembly 200 may be 90% or more, 92% or more, or 95% or more.

According to exemplary embodiments, a long-term perfluorinated compound removal efficiency of the catalyst assembly 200 may be 80% or more, 85% or more, 90% or more, or 92% or more.

When injecting a gas containing 300 ppm to 700 ppm of perfluorinated compound into the catalyst assembly 200 for 1 hour is set as one cycle, the initial perfluorinated compound removal efficiency may represent a perfluorinated compound removal efficiency within 50 cycles, and the long-term perfluorinated compound removal efficiency may represent a perfluorinated compound removal efficiency within 200 to 500 cycles.

For example, the removal efficiency of the perfluorinated compound may be calculated according to Equation 5 below.

$$Perfluorinated compound removal efficiency ( \% ) = \{ 1 - ( {C}_{E} / {C}_{I} ) \} \times 100 \qquad [ Equation 5 ]$$

In Equation 5, C_{E} is a concentration of the perfluorinated compound at an outlet of the reactor, and Cris a concentration of the perfluorinated compound at an inlet of the reactor.

The removal efficiency of the perfluorinated compound may represent a removal efficiency at a reaction temperature of 650° C. or higher, or 700° C., unless a separate reaction temperature is described. In general, a high conversion rate of the perfluorinated compound decomposition may be implemented at 700° C. or higher. However, when including the catalyst according to the above-described embodiments, a high conversion rate thereof may be implemented even at a relatively low temperature due to the improvement in gas flowability, the increase in the surface area of the catalyst 100, and/or the increase in heat transfer efficiency.

According to exemplary embodiments of the present invention, a method for decomposition of perfluorinated compounds using the above-described catalyst or catalyst assembly is provided.

According to exemplary embodiments, the catalyst assembly 200 for decomposition of perfluorinated compounds may be prepared. The catalyst assembly 200 may be, for example, an assembly of the above-described catalysts 100.

According to exemplary embodiments, the gas containing perfluorinated compounds may be injected into one surface of the catalyst assembly for decomposition of perfluorinated compounds.

For example, the gas containing perfluorinated compounds and the above-described catalyst or catalyst assembly may be brought into contact with each other in a predetermined reaction temperature range to decompose the perfluorinated compounds.

Examples of the perfluorinated compounds include completely perfluorinated compounds such as CF₄, C₂F₆, C₃F₈, and C₄F₁₀, etc.; incompletely perfluorinated compounds such as CHF₃, CH₂F₂, C₂HF₅, C₃HF₇, and C₄HF₉, etc.; perfluorooctanoic acid, perfluorosulfonic acid, perfluorobutanoic acid, and perfluorononanoic acid, etc. For example, the perfluorinated compounds may include compounds generated in the semiconductor manufacturing process. In one embodiment, the perfluorinated compound may include CF₄.

According to exemplary embodiments, the perfluorinated compound may be decomposed at a temperature of 650° C. or higher, 650° C. to 800° C., or 650° C. to 750° C.

According to exemplary embodiments, a content of the perfluorinated compounds in the gas containing perfluorinated compounds may be 100 ppm to 1,000 ppm, 200 ppm to 900 ppm, 250 ppm to 850 ppm, or 300 ppm to 800 ppm.

According to exemplary embodiments, the gas containing perfluorinated compounds may include moisture (H₂O). For example, the above-described differential pressure may be calculated by calculating a partial pressure of water vapor.

According to exemplary embodiments, a content of moisture in the gas containing perfluorinated compounds may be 1% by volume (“vol %”) to 20 vol %, 3 vol % to 17 vol %, 5 vol % to 15 vol %, or 6 vol % to 12 vol %.

The gas containing perfluorinated compounds may include air as the balance.

Hereinafter, specific experimental examples are proposed to facilitate understanding of the present invention. However, the following examples are only given for illustrating the present invention and those skilled in the art will obviously understand that various alterations and modifications are possible within the scope and spirit of the present invention. Such alterations and modifications are duly included in the appended claims.

### EXAMPLES AND COMPARATIVE EXAMPLES

### Example 1

100 parts by weight (“wt parts”) of raw material paste was prepared by mixing 70 wt parts of alumina and 30 wt parts of a molding aid and a metal additive including zirconium oxide, zinc oxide, etc. The raw material paste was extrusion molded to prepare a precatalyst having a honeycomb shape including channels with a rectangular cross-section. The precatalyst was sequentially dried and degreased at about 100° C. for 2 hours and about 400° C. for 2 hours.

Thereafter, the precatalyst was subjected to calcination at a temperature of about 750° C. to prepare a honeycomb-shaped catalyst.

The catalyst was prepared to have a density of 0.7 kg/L, a porosity of 35, a catalyst material distribution index of 152.25, and a CPSI of 100.

### Examples 2 to 4

Catalysts were prepared according to the same procedures as described in Example 1, except that the density of the catalyst was changed to 0.4 kg/L, 1.0 kg/L and 1.1 kg/L, respectively, by adjusting the condition of extrusion molding, drying condition, calcination condition and the like.

### Examples 5 to 8

Catalyst were prepared according to the same procedures as described in Example 1, except that the porosity according to Equation 1 below was changed to 10, 50.5, 68.8 and 82.3, respectively, by adjusting the condition of extrusion molding, drying condition, calcination condition and the like.

$$Porosity = ( PV / PD ) \times {10}^{4} \qquad [ Equation 1 ]$$

In Equation 1, PV is a numerical value of the volume of the pores included per unit mass (cm³/g) of the catalyst, and PD is a numerical value of the average diameter (A) of the pores included in the catalyst.

The volume of the pores included per unit mass and the average diameter of the pores in the catalyst were measured by nitrogen adsorption method (BET analysis). In addition, the volume of pores and the average diameter of pores were represented as values measured after the prepared catalyst was exposed to 500° C.

### Examples 9 to 12

Catalysts were prepared according to the same procedures as described in Example 1 except that the catalyst material distribution index according to Equation 2 below was changed to 80, 100, 200 and 400, respectively, by adjusting the structure of the honeycomb-shaped catalyst, the condition of extrusion molding, drying condition, calcination condition and the like.

$$Catalyst material distribution index = \{ D \times ( L 1 / L 2 ) \} \times 100 \qquad [ Equation 2 ]$$

In Equation 2, D is a numerical value of a density (kg/L) of a catalyst material included in the catalyst, L1 is a numerical value of a length (mm) of the channel of the catalyst, and L2 is a numerical value of the shortest distance (corresponding to the thickness of the partition wall 106) (mm) between two adjacent channels of the catalyst.

### Examples 13 to 17

Catalysts were prepared according to the same procedures as described in Example 1, except that the structure of the honeycomb-shaped catalyst was adjusted to change the number of channels per square inch (CPSI) to 20, 30, 50, 150 and 200, respectively.

### Examples 18 to 21

Catalysts were prepared according to the same procedures as described in Example 1, except that the content of the alumina was changed to 40 wt %, 50 wt %, 95 wt % and 98 wt %, respectively.

### Comparative Example 1

A catalyst was prepared according to the same procedures as described in Example 1, except that the catalyst was prepared in a pellet shape while having the same content of alumina.

### Comparative Example 2

A catalyst was prepared according to the same procedures as described in Example 1, except that the catalyst was prepared in a cylinder shape including a through hole (ø3±0.5 mm) while having the same content of alumina.

### Comparative Example 3

A catalyst was prepared according to the same procedures as described in Example 1, except that the density of the catalyst was changed to 0.3 kg/L by adjusting the condition of extrusion molding, drying condition, calcination condition and the like.

### EXPERIMENTAL EXAMPLE

### (1) Evaluation of Perfluorinated Compound Removal Efficiency

The catalysts according to the examples and comparative examples were processed into a 3-inch cylindrical shape with a volume of 12 L, respectively, and filled into a 3-inch Inconel reaction tube. The reaction temperature was adjusted to 700° C. using an external heater, and a gas containing 500 ppm of perfluorinated compound (tetrafluoromethane (CF₄)) was passed through the Inconel reaction tube for 1 hour. The reactant was analyzed using Fourier transform infrared spectroscopy (FT-IR), and the removal efficiency of the perfluorinated compound was calculated. Specific reaction conditions and the removal efficiency of the perfluorinated compound are as follows, and experimental results are shown in Tables 1 to 5 below.

### [Reaction Conditions]

i) Air flow rate: 40 L/min
ii) Distilled water flow rate: 23 mL/min
iii) Space velocity: 2,000/hr

### [Perfluorinated Compound Removal Efficiency Calculation Equation]

$$Removal efficiency ( \% ) = \{ 1 - ( {C}_{E} / {C}_{I} ) \} \times 100$$

In the perfluorinated compound removal efficiency calculation equation, C_{E} is a concentration of the perfluorinated compound at an outlet of the reaction tube, and C_{I} is a concentration of the perfluorinated compound at an inlet of the reaction tube.

TABLE 1

| | | Perfluorinated compound removal |
|---|---|---|
| Item | Density (kg/L) | efficiency (initial) (%) |
| Example 1 | 0.7 | 98 |
| Example 2 | 0.4 | 97 |
| Example 3 | 1.0 | 98 |
| Example 4 | 1.1 | 95 |
| Comparative | 0.3 | 93 |
| Example 3 | | |

TABLE 2

| | | Perfluorinated compound removal |
|---|---|---|
| Item | Porosity | efficiency (initial) (%) |
| Example 1 | 35 | 98 |
| Example 5 | 10 | 92 |
| Example 6 | 50.5 | 96 |
| Example 7 | 68.8 | 97 |
| Example 8 | 82.3 | 90 |

TABLE 3

| | | Perfluorinated compound removal |
|---|---|---|
| Item | CPSI | efficiency (initial) (%) |
| Example 1 | 100 | 98 |
| Example 13 | 20 | 85 |
| Example 14 | 30 | 90 |
| Example 15 | 50 | 92 |
| Example 16 | 150 | 98 |
| Example 17 | 200 | 98 |
| Comparative | (pellet) | 95 |
| Example 1 | | |
| Comparative | (cylinder) | 90 |
| Example 2 | | |

TABLE 4

| | Alumina content | Perfluorinated compound removal |
|---|---|---|
| Item | (wt %) | efficiency (initial) (%) |
| Example 1 | 70 | 98 |
| Example 18 | 40 | 89 |
| Example 19 | 50 | 96 |
| Example 20 | 95 | 94 |
| Example 21 | 98 | 87 |

Referring to Table 1, it was shown that the perfluorinated compound removal efficiency of the catalysts according to the examples was high. In Comparative Example 3 where the catalyst density was low, the perfluorinated compound removal efficiency was decreased. In addition, in Example 4 where the catalyst density was relatively higher than that of the other examples, the perfluorinated compound removal efficiency was relatively decreased.

Referring to Table 2, in Example 5 where the porosity according to Equation 1 was relatively lower than that of other examples, the perfluorinated compound removal efficiency was relatively decreased. In addition, also in Example 8 where the porosity according to Equation 1 was relatively higher than that of other examples, the perfluorinated compound removal efficiency was relatively decreased.

Referring to Table 3, the perfluorinated compound removal efficiency of the pellet-shaped or cylinder-shaped catalysts according to the comparative examples was decreased. In addition, in Examples 13 and 14 where CPSI was relatively lower than that of other examples, the perfluorinated compound removal efficiency was decreased.

Referring to Table 4, in Example 18 where the alumina content was relatively lower than that of other examples, the perfluorinated compound removal efficiency was relatively decreased. In addition, also in Example 21 where the alumina content was relatively higher than that of other examples, the perfluorinated compound removal efficiency was relatively decreased.

### (2) Evaluation of Lifespan Characteristics

A gas containing perfluorinated compounds was passed through the catalyst under the same conditions as (1) above. After repeating for 300 hours, the removal efficiency of the perfluorinated compounds was calculated. Results of the lifespan characteristic evaluation are shown in Tables 5 to 8 below.

TABLE 5

| Item | Porosity | Lifespan characteristics evaluation (%) |
|---|---|---|
| Example 1 | 35 | 98 |
| Example 5 | 10 | 50 |
| Example 6 | 50.5 | 96 |
| Example 7 | 68.8 | 94 |
| Example 8 | 82.3 | 60 |

TABLE 6

| | Catalyst distribution | Lifespan characteristics |
|---|---|---|
| Item | index | evaluation (%) |
| Example 1 | 152.25 | 98 |
| Example 9 | 80 | 70 |
| Example 10 | 100 | 93 |
| Example 11 | 200 | 96 |
| Example 12 | 400 | 82 |

TABLE 7

| | | Lifespan characteristics |
|---|---|---|
| Item | Alumina content (weight %) | evaluation (%) |
| Example 1 | 70 | 98 |
| Example 18 | 40 | 82 |
| Example 19 | 50 | 94 |
| Example 20 | 95 | 90 |
| Example 21 | 98 | 60 |

Referring to Table 5, in Example 5 where the porosity according to Equation 1 was relatively lower than that of other examples, the lifespan characteristics were decreased. In addition, also in Example 8 where the porosity according to Equation 1 was relatively higher than that of other examples, the lifespan characteristics were decreased.

Referring to Table 6, in Example 9 where the catalyst material distribution index was relatively lower than that of other examples, the lifespan characteristics were decreased. In addition, also in Example 12 where the catalyst material distribution index was relatively higher than that of other examples, the lifespan characteristics were relatively decreased.

Referring to Table 7, in Example 18 where the alumina content was relatively lower than that of other examples, the lifespan characteristics were relatively decreased. In addition, also in Example 21 where the alumina content was relatively higher than that of other examples, the lifespan characteristics were decreased.

### (3) Evaluation of Strength Reduction Rate

The strength reduction rate was evaluated according to Equation 3 below. Evaluation results are shown in Tables 9 and 10 below.

$$Strength reduction rate ( \% ) = 100 - [ \{ 1 - ( SE / SI ) \} \times 100 ] \qquad [ Equation 3 ]$$

In Equation 3, S_{E} is a strength of the catalyst measured after passing a gas containing perfluorinated compounds for 300 hours, and S_{I} is a strength of the catalyst measured without passing the gas containing perfluorinated compounds.

TABLE 8

| Item | Porosity | Strength reduction rate evaluation (%) |
|---|---|---|
| Example 1 | 35 | 6 |
| Example 5 | 10 | 15 |
| Example 6 | 50.5 | 4 |
| Example 7 | 68.8 | 10 |
| Example 8 | 82.3 | 11 |

TABLE 9

| | Catalyst distribution | Strength reduction rate |
|---|---|---|
| Item | index | evaluation (%) |
| Example 1 | 152.25 | 6 |
| Example 9 | 80 | 35 |
| Example 10 | 100 | 12 |
| Example 11 | 200 | 15 |
| Example 12 | 400 | 18 |

Referring to Table 8, in Example 5 where the porosity according to Equation 1 was relatively lower than that of other examples, the strength reduction rate of the catalyst was relatively high. In addition, also in Example 8 where the porosity according to Equation 1 was relatively higher than that of other examples, the strength reduction rate of the catalyst was relatively high.

Referring to Table 9, in Example 9 where the catalyst material distribution index was relatively lower than that of other examples, the strength reduction rate of the catalyst was relatively high.

### (4) Evaluation of Pressure Loss

The pressure loss of the catalyst according to the examples and comparative examples was measured. Specifically, the pressure loss depending on the flow rate per unit area was measured using a pressure gauge based on 90 CMM/m2 while injecting the gas in one direction into the catalyst. Measurement results are shown in Table 10 below.

TABLE 10

| Item | CPSI | Pressure loss evaluation (mmH₂O/mm) |
|---|---|---|
| Example 1 | 100 | 0.09 |
| Example 13 | 20 | 0.01 |
| Example 14 | 30 | 0.04 |
| Example 15 | 50 | 0.06 |
| Example 16 | 150 | 0.18 |
| Example 17 | 200 | 0.28 |
| Comparative | (pellet) | 0.40 |
| Example 1 | | |
| Comparative | (cylinder) | 0.18 |
| Example 2 | | |

Referring to Table 10, in Example 17 where CPSI was relatively higher than that of other examples, the pressure loss was relatively increased. In addition, the pressure loss of the pellet-shaped or cylinder-shaped catalyst according to the comparative examples was increased.

### (5) Evaluation of Surface Area Reduction Rate

The surface area reduction rate of the catalyst according to the examples was evaluated according to Equation 4 below. Evaluation results are shown in Table 11 below.

$$Surface area reduciton rate ( \% ) = 100 - [ \{ 1 - ( {A}_{E} / {A}_{I} ) \} \times 100 ] \qquad [ Equation 4 ]$$

In Equation 4, A_{E} is a surface area of the catalyst measured after exposure to 950° C. for 4 hours, and A_{I} is a surface area of the catalyst measured without exposure to heat.

TABLE 11

| Item | Alumina content (wt %) | TABLE area reduction rate (%) |
|---|---|---|
| Example 1 | 70 | 40 |
| Example 18 | 40 | 20 |
| Example 19 | 50 | 35 |
| Example 20 | 95 | 60 |
| Example 21 | 98 | 70 |

Referring to Table 11, in Examples 20 and 21 where the content of alumina is relatively higher than that of other Examples, the surface area reduction rate was relatively increased.

What is claimed is:

1. A honeycomb-shaped catalyst for decomposition of perfluorinated compounds, comprising:
a body having a first surface and a second surface facing the first surface, the body having partition walls configured to define a plurality of channels;
the plurality of channels which penetrate the body from the first surface to the second surface of the body; and
wherein the honeycomb-shaped catalyst includes aluminum oxide and the honeycomb-shaped catalyst has a density of 300 g/L or more.

2. The honeycomb-shaped catalyst of claim 1, wherein the honeycomb-shaped catalyst has a density of 400 g/L to 1,000 g/L.

3. The honeycomb-shaped catalyst of claim 1, wherein the honeycomb-shaped catalyst has the number of channels per square inch (CPSI) of 30 to 150.

4. The honeycomb-shaped catalyst of claim 1, wherein the body further includes pores having an average diameter of 50 Å to 300 Å.

5. The honeycomb-shaped catalyst of claim 4, wherein a volume of the pores included per unit mass of the honeycomb-shaped catalyst is 0.2 cm³/g to 0.6 cm³/g.

6. The honeycomb-shaped catalyst of claim 4, wherein the honeycomb-shaped catalyst has a porosity of 10 to 100, which is defined by Equation 1 below:
$$Porosity = ( PV / PD ) \times {10}^{4} \qquad [ Equation 1 ]$$
wherein, in Equation 1, PV is a numerical value of the volume of the pores included per unit mass (cm³/g) of the catalyst, and PD is a numerical value of the average diameter (Å) of the pores included in the catalyst.

7. The honeycomb-shaped catalyst of claim 1, wherein the honeycomb-shaped catalyst has a surface area per unit mass of 40 m²/g or more.

8. The honeycomb-shaped catalyst of claim 1, wherein the honeycomb-shaped catalyst has a catalyst material distribution index of 70 to 500, which is defined by Equation 2 below:
$$Catalyst material distribution index = \{ D \times ( L 1 / L 2 ) \} \times 100 \qquad [ Equation 2 ]$$
wherein, in Equation 2, D is a numerical value of a density (kg/L) of the catalyst, L1 is a numerical value of a length (mm) of the channel of the catalyst, and L2 is a numerical value of the shortest distance (mm) between two adjacent channels of the catalyst.

9. The honeycomb-shaped catalyst of claim 1, wherein a content of the aluminum oxide is 40% by weight to 95% by weight based on a total weight of the catalyst.

10. The honeycomb-shaped catalyst of claim 1, wherein the aluminum oxide comprises at least one of alpha-alumina (α-Al₂O₃), beta-alumina (β-Al₂O₃), gamma-alumina (γ-Al₂O₃), delta-alumina (δ-Al₂O₃), theta-alumina (θ-Al₂O₃) and kappa-alumina (κ-Al₂O₃).

11. The honeycomb-shaped catalyst of claim 1, wherein the honeycomb-shaped catalyst has a strength reduction rate of 45% or less, which is defined by Equation 3 below:
$$Strength reduction rate ( \% ) = 100 - [ \{ 1 - ( {S}_{E} / {S}_{I} ) \} \times 100 ] \qquad [ Equation 3 ]$$
wherein, in Equation 3, S_{E} is a strength of the honeycomb-shaped catalyst measured after passing a gas containing perfluorinated compounds for 300 hours, and S_{I} is a strength of the honeycomb-shaped catalyst measured without passing the gas containing perfluorinated compounds.

12. The honeycomb-shaped catalyst of claim 1, wherein the honeycomb-shaped catalyst has a surface area reduction rate of 75% or less, which is defined by Equation 4 below:
$$Surface area reduction rate ( \% ) = 100 - [ \{ 1 - ( {A}_{E} / {A}_{I} ) \} \times 100 ] \qquad [ Equation 4 ]$$
wherein, in Equation 4, A_{E} is a surface area of the honeycomb-shaped catalyst measured after exposure to 950° C. for 4 hours, and A_{I} is a surface area of the honeycomb-shaped catalyst measured without exposure to heat.

13. A honeycomb-shaped catalyst assembly for decomposition of perfluorinated compounds, comprising a plurality of the honeycomb-shaped catalysts of claim 1, which are stacked so that channels of the catalysts are connected with each other.

14. A method for removing perfluorinated compounds, the method comprising:
preparing the honeycomb-shaped catalyst assembly of claim 13; and
injecting a gas containing perfluorinated compounds into one surface of the honeycomb-shaped catalyst assembly for decomposition of perfluorinated compounds.
